(19) United States
(12) Patent Application Publication
(10) Pub. No.: US 2025/0370711 A1
(43) Pub. Date: Dec. 4, 2025

(54) MULTIPLYING ACCUMULATION WITH SHIFTING BASED ON MAXIMUM MANTISSA PRODUCT BITLENGTH

(71) Applicant: UNTETHER AI CORPORATION, Toronto (CA)

(72) Inventors: William Martin Snelgrove, Toronto (CA); Andrew Vincent Rock, Toronto (CA); David Lewis, Toronto (CA); Lui Ray Lam, Lexington, MA (US); Jonathan Andrew Scobbie, Toronto (CA)

(21) Appl. No.: 18/925,833

(22) Filed: Oct. 24, 2024

Related U.S. Application Data
(60) Provisional application No. 63/653,478, filed on May 30, 2024.

(51) Int. Cl. G06F 7/523; G06F 5/01

(52) U.S. Cl. CPC G06F 7/523; G06F 5/01

(57) ABSTRACT

A device, such as a multiplying accumulator or at-memory or single instruction, multiple data (SIMD) processing element, is configured to receive numbers defined by an encoding that specifies mantissa and exponent. A product of the mantissas is computed. The product is left shifter by a sum of the exponents and a selectable shift to obtain a left-shifted product. The selectable shift may be based on a selectable radix point, exponent biases, and a maximum mantissa product bitlength. Products may be accumulated. Left-shifted product, whether an intermediate or final result, may be right-shifter by a number of bits that is based on the maximum mantissa product bitlength.

### BACKGROUND

Computing devices perform operations on numbers, which may be represented by various binary encodings. Computer processors are often general purpose in nature and are typically able to handle different encodings. Computer software allows for a virtually infinite number of encodings that are not necessarily natively supported by hardware.

### BRIEF DESCRIPTION OF THE FIGURES

FIG. 1 is a block diagram of an example device to perform a multiply accumulate operation.

FIG. 2 is a flowchart of a method for performing a multiply accumulate operation.

FIG. 3 is a block diagram of another example device to perform a multiply accumulate operation.

FIG. 4 is a block diagram of an example device to perform parallel multiply accumulate operations.

### DETAILED DESCRIPTION

Efficiency can be gained by considering binary encodings when designing computing device hardware and vice versa. The number and/or complexity of hardware components can be reduced when an encoding is designed with the underlying hardware in mind. Conversely, an encoding specifically designed for specific hardware can increase computational throughput.

Disclosed herein are devices, methods, and encodings that are well suited to each other and that are specifically useful for at-memory or single instruction, multiple data (SIMD) computing devices. At-memory and SIMD devices are particularly susceptible to inefficiencies in processor design because this class of computing device typically includes hundreds or thousands of processors. The techniques discussed herein allow for reduced complexity in processors that perform numerous multiply accumulations, as is often required for artificial intelligence (AI) programs.

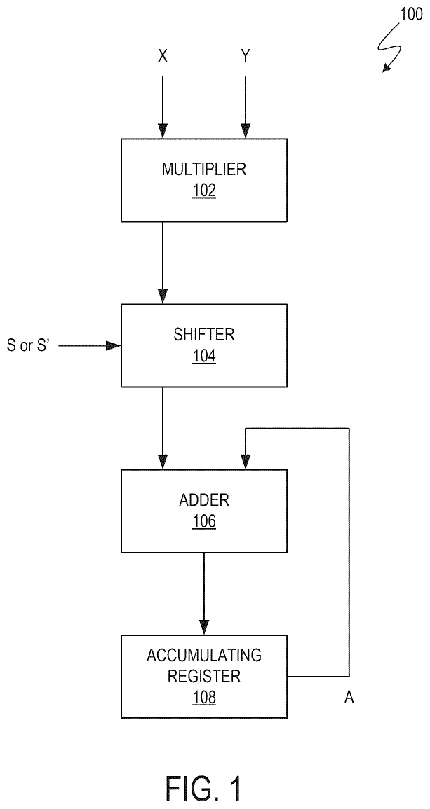

FIG. 1 shows an example device 100 configured to perform a multiply-accumulation. The device 100 includes circuitry that implements a multiplier 102, a shifter 104, and an adder 106, and an accumulating register 108. The device 100 may be considered a processor or may form part of a processor. For example, the device 100 can be provided as a multiplying accumulator (MAC) in each processing element (PE) of a SIMD or at-memory computing device.

The multiplier 102 includes two inputs for receiving multiplicands and an output for outputting a product. The multiplication are operands and may be termed first and second or x and y. The multiplier 102 is configured to multiply the mantissas of the two multiplicands to compute a mantissa product.

Each input may be a number that is encoded as a sequence of bits that includes sign bit, one or more exponent bits, and one or more mantissa bits. Each multiplicand may also be associated with an exponent bias that is subtracted from the exponent to provide for a desired range of numbers that may be represented. In general, an input x may be encoded as a sequence of bits as follows:

$$( sign , mantissa , exponent , bias ) = ( {s}_{x} , {m}_{x} , {e}_{x} , {B}_{x} )$$

Floating point inputs may be decoded in the standard way, respecting subnormals. Integer inputs may be decoded with exponent and bias of zero, i.e., ex=Bx=0.

Decoded input x may be expressed as follows:

$$x = {s}_{x} {m}_{x} 2 \hat{} ( {e}_{x} - {B}_{x} )$$

In this example, the multiplier 102 computes a mantissa product and the shifter 104 accounts for the exponents and biases, as will be discussed below.

The adder 106 includes two inputs for receiving two operands, namely, the product output by the shifter 104 and an accumulated value from the accumulating register 108. The adder is configured to add the two addends to obtain a sum. The adder 106 includes an output for outputting its result as the new accumulated value.

The accumulating register 108 is configured to receive an input for storing new accumulated values from the adder 106 and may provide its current accumulated value to the adder 106. The device 100 (i.e., functioning as a multiplying accumulator) may include a selectable radix point R that is fixed during accumulation but may be considered floating external to the device, such as in the software domain.

With the device 100, the product of two inputs x and y may be expressed as follows:

$$( {s}_{x} {s}_{y} ) ( {m}_{x} {m}_{y} ) 2 \hat{} ( {e}_{x} + {e}_{y} - ( {B}_{x} + {B}_{y} ) )$$

In a conventional multiplying accumulator, the accumulator is a floating-point accumulator because of the relatively large dynamic range. Integer accumulation may be less computationally intensive and/or may use less power because no normalization is required. However, conventional integer accumulators must be relatively quite large to accommodate floating point products. For instance, with an 8-bit encoding that has a sign bit, four exponent bits, and three mantissa bits, an integer accumulator may require 40 or more bits.

The flexibility provided by the device 100 with its tunable radix point R reduces the necessary accumulator size (e.g., 24 bits vs 40 bits). Thus, a multiply accumulation operation A that may be expressed as follows:

$$A += ( {s}_{x} {s}_{y} ) ( {m}_{x} {m}_{y} ) 2 \hat{} ( {e}_{x} + {e}_{y} + R - ( {B}_{x} + {B}_{y} ) )$$

The device 100 may be configured to receive a third operand that is defined as a shift S. The shifter 104 may receive and apply the shift S or modified shift S′, as will be discussed below.

The shift S may be defined to include the selectable radix point, a first bias of the first exponent, and a second bias of the second exponent, that is:

$$S = R - ( {B}_{x} + {B}_{y} )$$

The shift S replaces the defined values and is added to the exponents of the multiplicands, so that the multiply accumulation operation A becomes the following:

$$A += ( {s}_{x} {s}_{y} ) ( {m}_{x} {m}_{y} ) 2 \hat{} ( {e}_{x} + {e}_{y} + S )$$

The shift S allows joint selection of the exponent biases Bₓ, B_{y} and the radix point R with a single integer.

Further, if the maximum mantissa product has k bits, then right shifts of up to k−1 are reasonable. Thus, the multiply accumulation operation A may be further configured with a pre-shift as follows:

$$A += ( {s}_{x} {s}_{y} ) ( {m}_{x} {m}_{y} ) ≪ ( {e}_{x} + {e}_{y} + S + ( k - 1 ) ) ≫ ( k - 1 )$$

As such, the mantissa product is left shifted (shifted towards most-significant bit or MSB) by the shift S to account for the selectable radix point and exponent biases and further by a value that is based on a maximum mantissa product bitlength, which in this example is the maximum mantissa product bitlength minus one, i.e., k−1. This avoids conditional shifts that may otherwise be required and thus simplifies the hardware implementation.

The bitlength of the maximum mantissa product bitlength may be governed by the component(s) used for the multiplier 102, shifter 104, adder 104, and/or accumulator 106. The maximum mantissa product bitlength is, in general terms, the largest number of storable bits for the mantissa product.

The shift S′ may be modified to include the pre-shift as follows:

$${S}^{′} = S + ( k - 1 )$$

Thus, the multiply accumulation operation A may be expressed as follows:

$$A += ( {s}_{x} {s}_{y} ) ( {m}_{x} {m}_{y} ) ≪ ( {e}_{x} + {e}_{y} + {S}^{′} ) ≫ ( k - 1 )$$

The mantissa product is left shifted by a sum of the exponents eₓ and e_{y} and the selectable shift S′ to obtain a left-shifted product. The left-shifted product is then right shifted (shifted towards least-significant bit or LSB) by the maximum mantissa product bitlength minus one, i.e., k−1.

The shifter 104 is configured to receive the selectable shift S′ from an external system, such as software. This further simplifies the hardware implementation of the device 100. Both S or S′ can be either positive or negative.

Alternatively, device 100 may be configured to receive the selectable shift S (without the k−1 term) from an external system, such as software. The device 100 adds the maximum mantissa product bitlength value (k−1) to the received selectable shift S.

In the example, device 100 includes a discrete shifter 104 configured to perform the left shift. In other examples, the shifter may be part of the multiplier 102 or the adder 106. A shifter configured to perform the right shift may be provided at an output of the accumulator 108 or at an external system. The right shift may be performed in software.

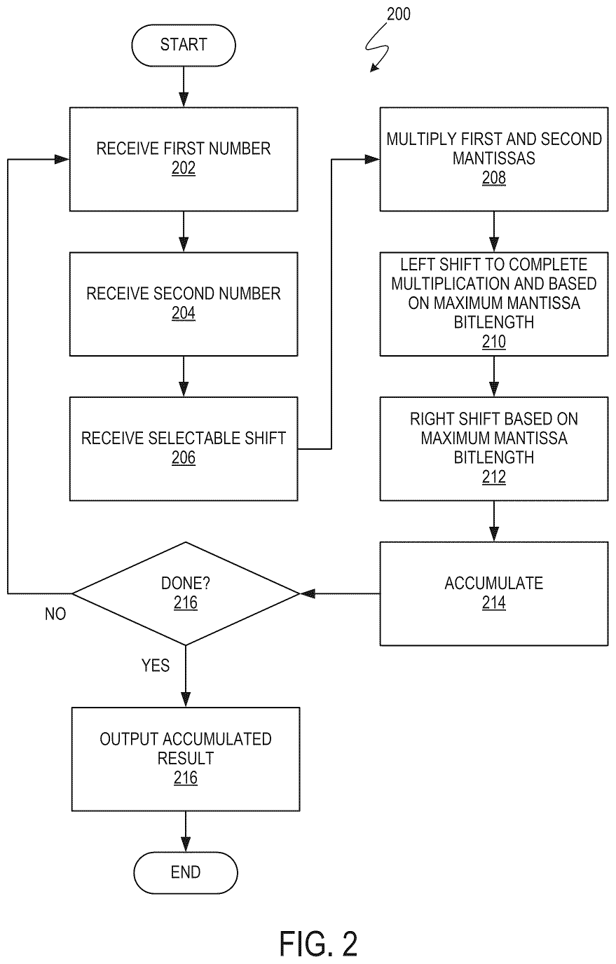

FIG. 2 shows a method 200 for performing a multiply accumulate operation. The method 200 may be implemented with hardware circuitry (e.g., see device 100 of FIG. 1), software, firmware, or a combination of hardware, software, and/or firmware. When partially or fully implemented as software or firmware, the method 200 may be implemented as instructions that are stored in a non-transitory machine-readable medium and executed by a processor.

At block 202, a first number is received. The first number is encoded by a binary encoding that includes bits for a first mantissa and a first exponent. The encoding may further include a first sign bit. The encoding may also define a first exponent bias that is added to the first exponent to provide the encoding with a desired scale or range.

At block 204, a second number is received. The second number is encoded by a binary encoding that includes bits for a second mantissa and a second exponent. The encoding may further include a second sign bit. The encoding may also define a second exponent bias that is added to the second exponent to provide the encoding with a desired scale or range. The encoding may be the same as the encoding of the first number.

At block 206, a selectable shift is received. The selectable shift may be defined as S or S′ discussed above. That is, the selectable shift S may be based on a radix point and the exponent biases of the first and second numbers. Alternatively, the selectable shift S′ may include the radix point, the exponent biases of the first and second numbers, and a number of bits that is based on a maximum mantissa product bitlength, i.e. the maximum mantissa product bitlength less one, k−1.

At block 208, the first mantissa and the second mantissa are multiplied, and a product is computed.

At block 210, the product is left shifted by the sum of the first exponent, the second exponent, and the selectable shift to obtain a left-shifted product. If the selectable shift does not include the number of bits indicative of the maximum mantissa product bitlength (e.g., k−1), a further left shift is performed for the maximum mantissa product bitlength (e.g., k−1). In any case, the mantissa product is left shifted by the total number of bits of the exponents, plus the radix point value, less the exponent biases, and plus the maximum mantissa product bitlength (e.g., k−1).

At block 212, the left-shifted product of block 210 is right shifted by the number of bits that is based on a maximum mantissa product bitlength (e.g., k−1) to obtain a right-shifted product. Left shifting at block 210 by a total number of bits that includes this amount (e.g., k−1) and then right shifting by this amount (e.g., k−1) ensures that the left shift of block 210 will always be a left shift and that the right shift of block 212 will always be a right shift, thereby avoiding the need to provide a decision block and/or corresponding hardware to determine the direction of a shift that would otherwise be performed instead of blocks 210 and 212. Because of the right shift (e.g., k−1), a negative left shift results in a zero output.

At block 214, the right-shifted product is accumulated. The result of block 212 may be added to the current accumulated result.

Blocks 202-214 may be repeated until the multiplying accumulation is complete which may occur when, for example, there are no more multiplicands, as determined at block 216.

Block 218 then outputs the result of the multiplying accumulation.

It should be apparent that various blocks of the method 200 may be performed in different sequences than described and that blocks may be combined or further divided in functionality. The particular order and content of the blocks is not intended to be limiting. For example, the first and second numbers may be received simultaneously. In another example, the right shift of block 212 may be performed only when the accumulated result is to be output at block 216.

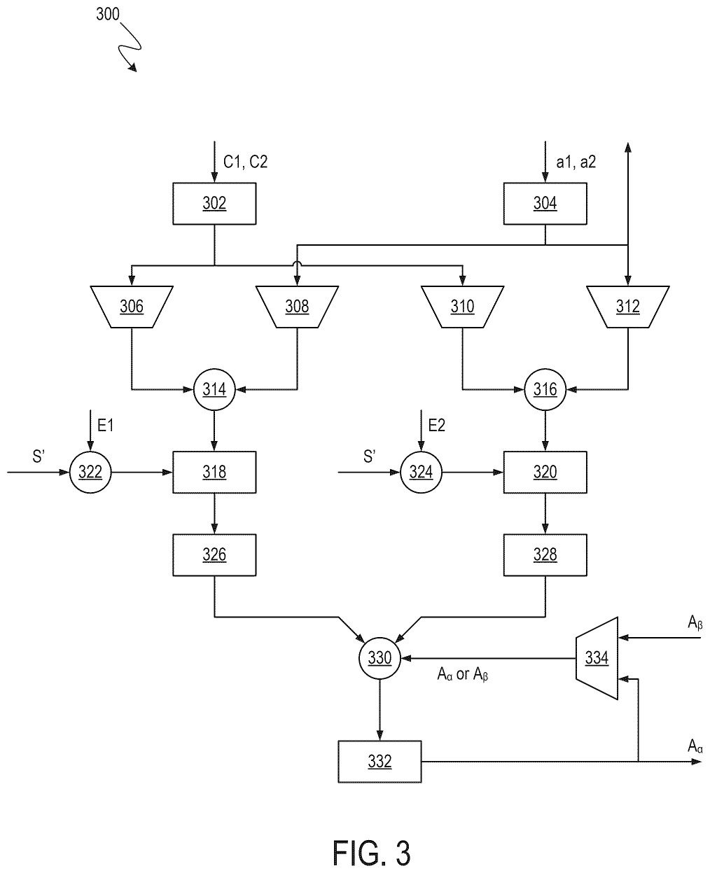

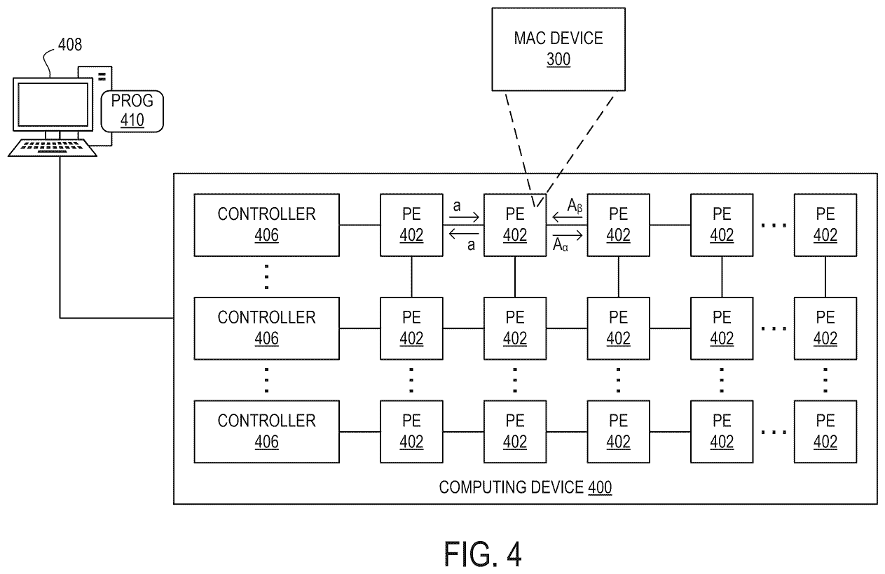

FIG. 3 shows an example device 300 to perform a multiply accumulate operation. The principles discussed above may be referenced for sake of understanding the device 300 and details previously described will not be repeated here. The device 300 is suitable for use within a processing element of an at-memory or SIMD device, such as that shown in FIG. 4.

The device 300 includes input registers 302, 304 to receive input numbers for multiplying accumulation. For example, the input register 302 may receive one or more coefficients, C, from memory associated with the device 300 and the other input register 304 may receive one or more activations, a, from another device 300 (where C and a are comparable to x and y). An activation may be output to another device 300 as well. Coefficients, C, and activations, a, accord to a binary encoding, such as those discussed above. Binary encodings may have four bits, eight bits, sixteen bits, or another suitable number of bits.

Coefficients, C, and activations, a, may belong to an AI program, such as a neural network, that requires a large throughput of matrix multiplications.

In this example, two parallel streams of multiplying accumulation are supported. A coefficient, C, and activation, a, may each be split into two parts, which are then multiplied. For example, coefficient, C, may be split into values C1 and C2, such that C=C1+C2. Likewise, activation, a, may be split into values a1 and a2, such that a=a1+a2. Four multiplications (i.e., C1·a1, C1·a2, C2·a1, and C2·a2) may be performed to obtain the product. Alternatively, two different coefficients, C, and two different activations, a, may be provided for multiplication.

To facilitate such multiplications, selectors 306, 310 are connected to the output of the register 302 and selectors 308, 312 are connected to the output of the register 304. The selectors 306-312 are controlled to provide the mantissas of two multiplicands, whether whole or partial, to subsequent multipliers 314, 316.

Each multiplier 314, 316 multiplies the two respective mantissas provided by respective selectors 306-312.

The device 300 further includes shift registers 318, 320. Each shift register 318, 320 is connected to the output of a respective multiplier 314, 316 to receive a value to be shifted. Each shift register 318, 320 is also connected to a respective adder 322, 324 to receive an indication of a shift amount. Each shift register 318, 320 is configured to perform a left shift (i.e., towards the MSB).

A selectable shift S′ is provided to each adder 322, 324, which adds the selectable shift S′ to a respective an exponent value E1, E2 that is the sum of the exponents that correspond to the multiplicands provided to the respective multiplier 314, 316. As discussed above, the selectable shift S′ includes values of respective exponent biases and a radix point and a value based on the maximum mantissa product bitlength that may be output by the multipliers 314, 316, such as the maximum mantissa product bitlength minus one, i.e., k−1. Exponent values E1, E2 are obtained from input registers 302, 304 according to the encoding used. The selectable shift S′ may be provided by an outside source, such as software or firmware that programs the device 300. A single selectable shift value S′ may be provided by an external source, such as a controller (not shown) that controls the device 300, a host that programs the device 300 and its controller, or other entity.

Each shift register 318, 320 outputs its shifted result to a respective register 326, 328.

Outputs of the registers 326, 328 are connected to an adder 330 that also receives a current accumulated result A_{α} or A_{β}. The adder 330 sums the results of the multiplications and the current accumulated result.

A register 332 is connected to the output of the adder 330 to store the accumulated result A_{α}, which may be output to a neighboring device 300 or controller (not shown) and ultimately to a host (not shown) that controls the device 300. The accumulated result A_{α} may be right shifted (towards LSB) by another shift register (not shown), the controller, or the host. The right shift may be performed by software or firmware when the true value of the accumulated result A_{α} is desired.

The device 300 may further include a selector 334 (e.g., a multiplexer) to select a current accumulated result as the current accumulated result A_{α} of the device 300 or an accumulated result A_{β} of a neighboring device 300.

FIG. 4 shows an example computing device 400 configured to perform parallel multiplying accumulations. The computing device 400 is a SIMD device, which may be termed an at-memory computing device. U.S. Pat. No. 11,881,872, which is incorporated herein by reference, may be referenced for additional details concerning devices that may be used or adapted to be used as the device 400.

The computing device 400 includes an array of processing elements or PEs 402. Processing elements 402 may be logically and, optionally, physically arranged in a two-dimensional array. Such an array may be considered to have rows and columns.

Each processing element 402 includes circuitry to perform a multiplying accumulation and, optionally, other computations. For example, each processing element 402 may include a device 300 discussed above.

Each processing element 402 includes or is connected to working memory dedicated to that processing element 402. A processing element 402 may be connected with one or more neighboring processing elements 402 to share information, such as activations, a, and/or accumulated results, A_{α}, A_{β}. Processing element interconnections may be provided in the row direction, the column direction, or both.

The computing device 400 further includes a controller 406 connected to a subset of processing elements 402 (e.g., a row or column of PEs). The controller 406 controls the connected processing elements 402 to perform the same operation on data contained in each processing element 402. The controller 406 may further control loading/retrieving of data to/from the processing elements 402, control the communication among processing elements 402, and/or control other functions for the processing elements 402. Any suitable number of controllers 406 may be provided to control the processing elements 402. Controllers 406 may be connected to each other for mutual communications.

The computing device 400 may further include a bus for communications among the controllers 406 and/or processing elements 402, direct memory access hardware to share information between memory of the processing elements, and other components (not shown).

The computing device 400 may be connected to a host system 408 that provides a program 410 to the computing device 400 and that expects output of the program during and/or after execution by the computing device 400. Such connection may be between the host system 408 and the controller(s) 406. The host system 408 may also provide a user interface and other components to support operations of the computing device 400. The host system 408 may be a conventional computing device, such as a desktop/notebook computer, server, smartphone, or vehicle-based computer.

The controller 406 is a processor (e.g., microcontroller, etc.) that may be configured with instructions to control the processing elements 402 to perform multiplying accumulations, as discussed above.

The processing elements 402 may share intermediate or final accumulated results with connected processing elements 402, so that multiplying accumulations may be performed across several processing elements 402. A final accumulated result may be reported to the controller 406, which may pass the result to the host system 408. In various examples, the controller 406 performs the right shift by the number of bits that is based on a maximum mantissa product bitlength (e.g., k−1). In various other examples, the program 410 at the host system 408 performs this right shift.

In addition, regarding rounding, a right shift of k−1 may drop bits. Instead, a result may be right shifted by k−2 bits, have a value of one added, and then be additionally right shifted by one bit. To make the multiplier less biased, rounding may be performed before multiplying by the sign. Such calculation may be described as follows:

$$P = {m}_{x} {m}_{y} ≪ ( {e}_{x} + {e}_{y} + {S}^{′} ) ≫ ( k - 2 )$$

$$P = ( P + 1 ) ≫ 1$$

$$A += {s}_{x} {s}_{y} P$$

In other words, the number of bits for the right shift is the maximum mantissa product bitlength minus two, and the multiplying accumulation circuitry or program is further configured to round the right-shifted product by incrementing the right-shifted product by one and further right shifting the right-shifted product by one bit.

It should be apparent from the above that the techniques described herein provide for efficient computation of multiplying accumulations. In particular, for example, conditional shifts are avoided, which simplifies hardware and may also simplify software or firmware.

It should be recognized that features and aspects of the various examples provided above can be combined into further examples that also fall within the scope of the present disclosure. In addition, the figures are not to scale and may have size and shape exaggerated for illustrative purposes.

1. A device comprising:
circuitry configured to:
receive a first number defined by a first mantissa and a first exponent;
receive a second number defined by a second mantissa and a second exponent;
receive a selectable shift;
compute a product of the first mantissa and the second mantissa;
left shift the product by a sum of the first exponent, the second exponent, and the selectable shift to obtain a left-shifted product; and
right shift the left-shifted product by a number of bits that is based on a maximum mantissa product bitlength to obtain a right-shifted product.

2. The device of claim 1, wherein the circuitry is configured to accumulate the right-shifted product.

3. The device of claim 1, wherein the circuitry is configured to accumulate the left-shifted product for a number of multiplications and left shifts before performing the right shift.

4. The device of claim 1, wherein the selectable shift is based on a selectable radix point, a first bias of the first exponent, and a second bias of the second exponent.

5. The device of claim 4, wherein the selectable shift is the selectable radix point minus a sum of the first bias and the second bias.

6. The device of claim 4, wherein the selectable shift is fixed for a sequence of multiplying accumulations performed with a sequence of received first and second numbers.

7. The device of claim 1, wherein the number of bits is the maximum mantissa product bitlength minus one.

8. The device of claim 1, wherein:
the number of bits is the maximum mantissa product bitlength minus two; and
the circuitry is further configured to round the right-shifted product by incrementing the right-shifted product by one and further right shifting the right-shifted product by one bit.

9. The device of claim 1, wherein:
the first number is further defined by a first sign bit;
the second number is further defined by a second sign bit; and
the circuitry is further configured to apply the first sign bit and the second sign bit to the left-shifter product or the right-shifted product.

10. A circuit comprising:
a multiplier to multiply mantissas of binary numbers and output a mantissa product;
a shifter to left shift the mantissa product by a number of bits determined from exponents of the binary numbers and a maximum mantissa product bitlength that is storable to obtain an intermediate result;
an accumulator to accumulate the intermediate result to obtain a final result and output the final result.

11. The circuit of claim 10, wherein the shifter is further to right shift the intermediate result based on the maximum mantissa product bitlength.

12. The circuit of claim 10, wherein the final result is right shifter based on the maximum mantissa product bitlength.

13. The circuit of claim 10, further comprising another shifter to right shift the final result based on the maximum mantissa product bitlength.

14. The circuit of claim 10, wherein the shifter is to left shift the mantissa product further by a selectable radix point.

15. The circuit of claim 10, wherein the shifter is to left shift the mantissa product further by biases of the exponents.

16. A device comprising:
a controller; and
an array of processing elements configured with the controller for single instruction, multiple data operation, each processing element including a multiplying accumulator configured to:
multiply mantissas of binary numbers and output a mantissa product;
left shift the mantissa product by a number of bits determined from exponents of the binary numbers and a maximum mantissa product bitlength that is storable to obtain an intermediate result; and
accumulate the intermediate result to obtain a final result and output the final result.

17. The device of claim 16, wherein the multiplying accumulator is further configured to right shift the intermediate result based on the maximum mantissa product bitlength.

18. The device of claim 16, wherein the multiplying accumulator is further configured to right shift the final result based on the maximum mantissa product bitlength.

19. The device of claim 16, wherein the controller is configured to right shift the final result based on the maximum mantissa product bitlength.

20. The device of claim 16, wherein the controller is connectable to a host system that is configured to right shift the final result based on the maximum mantissa product bitlength.
